(19) United States
(12) Patent Application Publication
(10) Pub. No.: US 2015/0132165 A1
(43) Pub. Date: May 14, 2015

(54) HIGH-PRESSURE PUMP

(71) Applicant: DENSO CORPORATION, Kariya-city (JP)

(72) Inventors: Hiroshi INOUE, Anjo-city (JP); Eiji ITOH, Anjo-city (JP)

(21) Appl. No.: 14/539,498

(22) Filed: Nov. 12, 2014

(30) Foreign Application Priority Data
Nov. 12, 2013 (JP) 2013-233868

(51) Int. Cl. F02M 59/44; F02M 37/04

(52) U.S. Cl. CPC F02M 59/442; F02M 37/043
USPC 417/435

(57) ABSTRACT

A high-pressure pump includes a pump body, a cylinder, a plunger, and a plug. The pump body has a fuel chamber therein into which fuel is supplied. The cylinder is disposed inside the pump body and having one end immediately adjacent to the fuel chamber. The cylinder has an inner threaded portion formed on an inner wall of the cylinder at the one end. The plunger is disposed inside the cylinder and is reciprocally movable in an axial direction to change a volume of a pressurizing chamber within which the fuel supplied from the fuel chamber is pressurized. The plug is screwed into the inner threaded portion of the cylinder from the fuel chamber in the axial direction and closing the one end of the cylinder. The plug has an end surface that faces an end surface of the plunger and defines the pressurizing chamber together with the end surface of the plunger. The end surface of the plug is parallel to the end surface of the plunger.

### CROSS REFERENCE TO RELATED APPLICATION

This application is based on and incorporates herein by reference Japanese Patent Application No. 2013-233868 filed on Nov. 12, 2013.

### TECHNICAL FIELD

The present disclosure relates to a high-pressure pump.

### BACKGROUND

In the related art, a high-pressure pump is known which pressurizes fuel by a reciprocating movement of a plunger. The high-pressure pump increases pressure of the fuel which is directly injected into a cylinder of an internal combustion engine from an injector, thereby enabling atomization of the fuel and multiple injections. In this manner, fuel efficiency of a vehicle on which the high-pressure pump is mounted can be improved.

A high-pressure pump disclosed in a patent literature 1 (JP 2010-121452 A) includes a suction valve in a fuel supply passage which is formed on a counter plunger side of a pressurizing chamber for pressurizing the fuel. When descending of a plunger decreases pressure in the pressurizing chamber, the suction valve is opened. When ascending of the plunger increases the pressure in the pressurizing chamber, the suction valve is closed.

In the high-pressure pump, an opening on a counter pressurizing chamber side of the fuel supply passage having the suction valve is closed by screwing a plug thereinto. The high-pressure pump is allowed to have improved capability in maintenance such as replacement of the suction valve, since the plug is attachable to or detachable from the high-pressure pump.

### SUMMARY

According to the findings by the applicant, however, the high-pressure pump disclosed in the patent literature includes the suction valve on the counter plunger side of the pressurizing chamber. Consequently, a size of the high-pressure pump in an axial direction increases. If the suction valve is disposed to move in a radial direction of a cylinder, a volume of the pressurizing chamber is increased by a volume amount of the fuel supply passage having the suction valve. In this case, the fuel in the pressurizing chamber is less likely to have high pressure. As a result, there is a possibility that a discharge amount of high-pressure fuel discharged from the high-pressure pump decreases.

The plug included in the high-pressure pump disclosed in the patent literature is screwed from the outside of a pump body. Accordingly, if the fuel leaks out through a clearance between the plug and the pump body, the leaking fuel flows outward from the pump body.

It is an objective of the present disclosure to provide a high-pressure pump that can increase a discharge amount of high-pressure fuel and can prevent leakage of the high-pressure fuel.

In an aspect of the present disclosure, a high-pressure pump includes a pump body, a cylinder, a plunger, a plug, and a pressurizing chamber.

The pump body has a fuel chamber therein into which fuel is supplied. The cylinder is disposed inside the pump body and having one end of the cylinder immediately adjacent to the fuel chamber. The cylinder has an inner threaded portion formed on an inner wall of the cylinder at the one end. The plunger is disposed inside the cylinder and is reciprocally movable in an axial direction to change a volume of a pressurizing chamber within which the fuel supplied from the fuel chamber is pressurized. The plug is screwed into the inner threaded portion of the cylinder from the fuel chamber in the axial direction and closing the one end of the cylinder. The plug has an end surface that faces an end surface of the plunger and defines the pressurizing chamber together with the end surface of the plunger. The end surface of the plug is parallel to the end surface of the plunger.

According to the aspect of the present disclosure, this configuration can decrease the volume of the pressurizing chamber by installing the end surface of the plug so as to be close to a top dead center of the plunger. Therefore, when the plunger ascends, the high-pressure pump can cause the fuel of the pressurizing chamber to have high pressure in a short time. Accordingly, the high-pressure pump can increase a discharge amount of high-pressure fuel.

The plug is screwed into the cylinder from the fuel chamber. Therefore, when the fuel of the pressurizing chamber leaks out through a clearance between an inner threaded portion of the cylinder and the plug, the fuel flows into the fuel chamber. Accordingly, the high-pressure pump can prevent the fuel from leaking outward from the pump body.

### BRIEF DESCRIPTION OF THE DRAWINGS

The disclosure, together with additional objectives, features and advantages thereof, will be best understood from the following description, the appended claims and the accompanying drawings, in which:

FIG. 1 is a cross-sectional view illustrating a high-pressure pump according to a first embodiment of the present disclosure;

FIG. 2 is an enlarged view illustrating a portion of the high-pressure pump according to the first embodiment;

FIG. 3 is a characteristic view illustrating fuel discharge of a high-pressure pump according to the first embodiment and a comparative example;

FIG. 4 is a cross-sectional view illustrating a portion of a high-pressure pump according to a second embodiment;

FIG. 5 is a cross-sectional view taken along line V-V in FIG. 4;

FIG. 6 is a plan view illustrating a plug according to a modification to the second embodiment;

FIG. 7 is a cross-sectional view illustrating a portion of a high-pressure pump according to a third embodiment;

FIG. 8 is a cross-sectional view illustrating a portion of a high-pressure pump according to a fourth embodiment;

FIG. 9 is a cross-sectional view illustrating a portion of a high-pressure pump according to a fifth embodiment;

FIG. 10 is a cross-sectional view illustrating a portion of a high-pressure pump according to a sixth embodiment;

FIG. 11 is a cross-sectional view illustrating a portion of a high-pressure pump according to a seventh embodiment;

FIG. 12 is a cross-sectional view illustrating a portion of a high-pressure pump according to an eighth embodiment;

FIG. 13 is a cross-sectional view illustrating a portion of a high-pressure pump according to a ninth embodiment; and

FIG. 14 is a cross-sectional view illustrating a portion of a high-pressure pump according to a comparative example.

### DETAILED DESCRIPTION

A plurality of embodiments of the present disclosure will be described hereinafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

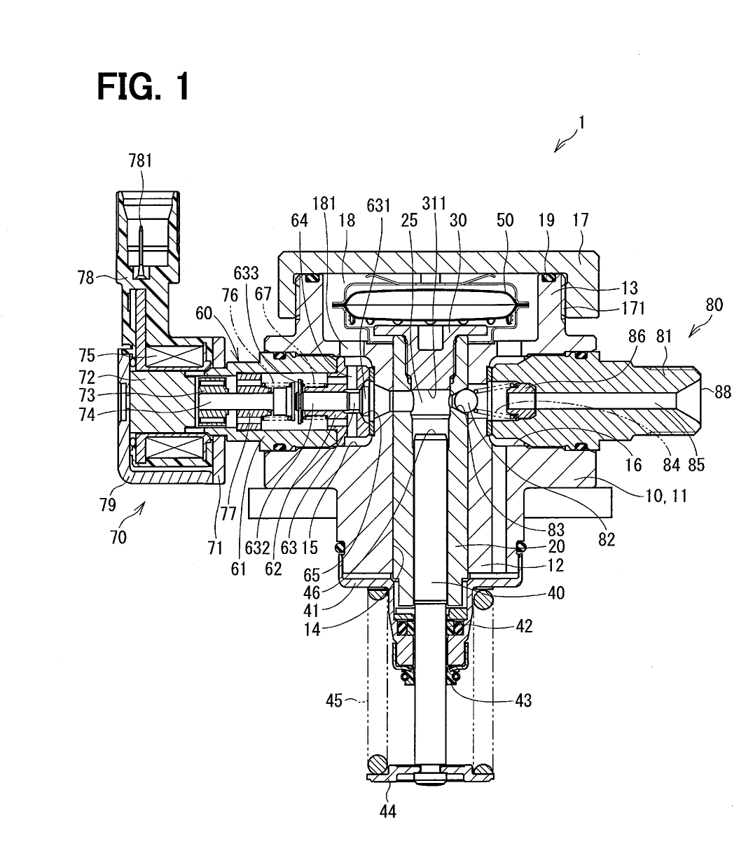

A first embodiment of the present disclosure is illustrated in FIGS. 1 to 3. A high-pressure pump 1 according to the first embodiment pressurizes fuel suctioned from a fuel tank (not illustrated) by a low-pressure pump, and discharges the fuel to a delivery pipe (not illustrated). The fuel whose pressure is accumulated in the delivery pipe is injected into a cylinder of an internal combustion engine from an injector connected to the delivery pipe.

Hereinafter, for the sake of convenience, an upper side in FIG. 1 is referred to as an “upper side” in the description, and a lower side is referred to as a “lower side” in the description.

As illustrated in FIG. 1, the high-pressure pump 1 includes a pump body 10, a cylinder 20, a plug 30, a plunger 40, a pulsation damper 50, a fuel supply unit 60, an electromagnetic drive unit 70, a fuel discharge unit 80, and the like.

The pump body 10 integrally has a pump body main body 11, an internal combustion engine attachment portion 12 located in the lower side of the pump body main body 11, and a cylindrical wall 13 extending upward in a cylindrical shape from the pump body main body 11.

The pump body 10 can be attached to the internal combustion engine by the internal combustion engine attachment portion 12 being inserted into an attachment hole (not illustrated) disposed in the internal combustion engine.

The pump body 10 has a cavity 14 penetrating in an axial direction. The cylinder 20 is press-fitted and fixed to the cavity 14. The pump body main body 11 has a fuel supply unit attachment hole 15 and a fuel discharge unit attachment hole 16 which penetrate in a radial direction of the cavity 14. The fuel supply unit 60 and the fuel discharge unit 80 will be described later.

In the pump body 10, a bottomed cylindrical-shaped cover 17 is fixed onto the cylindrical wall 13 by a threaded portion 171. In this manner, a fuel chamber 18 is formed inside the cylindrical wall 13 and the cover 17. An O-ring 19 disposed between an upper end surface of the cylindrical wall 13 and the cover 17 prevents fuel from leaking out from the fuel chamber 18. The fuel chamber 18 communicates with a fuel inlet (not illustrated). The fuel suctioned from the fuel tank is supplied to the fuel chamber 18 through the fuel inlet.

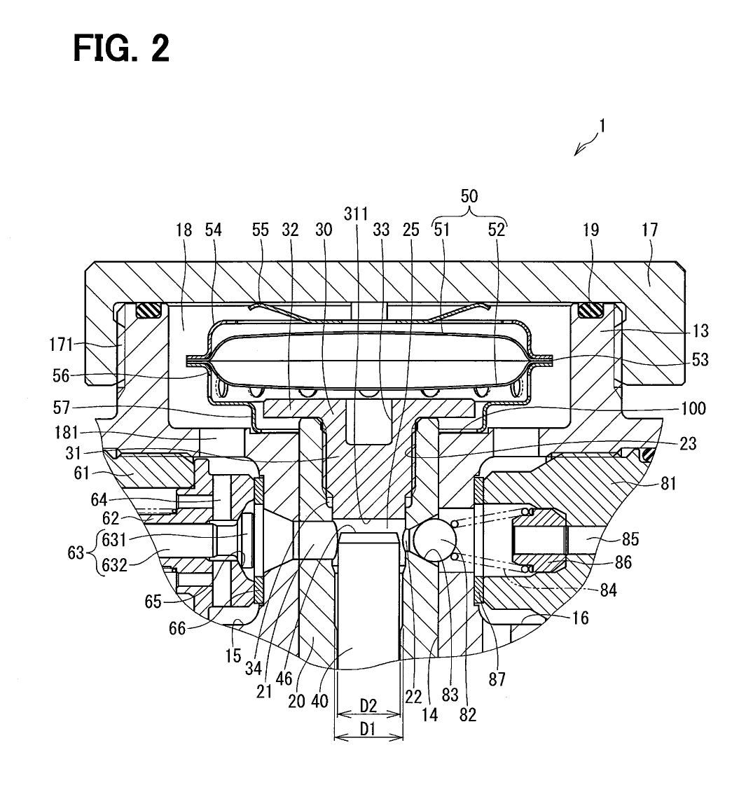

The cylinder 20 is formed in a cylindrical shape by using heat-treated martensitic-based stainless steel, for example, and is press-fitted and fixed to an inner wall of the cavity 14 of the pump body 10 in a sealed manner. As illustrated in FIG. 2, the cylinder 20 has a fuel supply hole 21 and a fuel discharge hole 22, respectively, at positions corresponding to the fuel supply unit attachment hole 15 and the fuel discharge unit attachment hole 16 of the pump body 10. In the cylinder 20, an inner diameter D1 at a position where the fuel supply hole 21 and the fuel discharge hole 22 are open and in the vicinity of the position is slightly larger than an inner diameter D2 on a lower side thereof.

The cylinder 20 has an end portion (one end) that is immediately adjacent to the fuel chamber 18 and is exposed to the fuel chamber 18, and an inner threaded portion 23 is formed on an inner wall at the end portion. The end portion of the cylinder 20 slightly protrudes toward the fuel chamber 18.

The plug 30 has an outer threaded portion 31 which extends in the axial direction and has a male screw formed on an outer periphery, and has a head portion 32 which extends radially outward in an annular shape from an end portion (one end) of the outer threaded portion 31 immediately adjacent to the fuel chamber 18. In the plug 30, the outer threaded portion 31 is screwed into the inner threaded portion 23 of the cylinder 20 from the fuel chamber 18. A hole 33 is disposed in the head portion 32 of the plug 30. When viewed in the axial direction, the hole 33 has a non-circular shape such as a hexagonal shape, a square shape, or a hexalobe shape. Therefore, a tool (not illustrated) for rotating the plug 30 can be attached to the hole 33. In the plug 30, the outer threaded portion 31 is screwed into the inner threaded portion 23 of the cylinder 20 by rotating the tool. An axial force generated during the screwing brings the head portion 32 of the plug 30 into sealed contact with an end surface of the end portion of the cylinder 20 in the axial direction, thereby closing an opening of the end portion of the cylinder 20. That is, the head portion 32 has sealed contact with the end portion of the cylinder 20. In a state where the plug 30 is attached to the cylinder 20, a space 34 is formed on the pressurizing chamber side of the inner threaded portion 23. Therefore, tensile stress is not applied to the cylinder 20 by the outer threaded portion 31 of the plug 30, but compressive stress in the axial direction is applied to the cylinder 20 from the head portion 32. Accordingly, delayed fracture of the cylinder 20 is prevented.

In the plug 30, an lower end surface 311 (end surface) on an opposite side of the plug 30 relative to the fuel chamber 18 forms an inner wall of a pressurizing chamber 25 as described below. The lower end surface 311 of the plug 30 is a flat surface which is formed in parallel to an upper end surface 46 (end surface) of the plunger 40 that faces the lower end surface 311 of the plug 30 in the pressurizing chamber 25.

As illustrated in FIG. 1, the plunger 40 protrudes to the lower side from the cylinder 20. An oil seal holder 41 is disposed on the lower side of the pump body 10. The oil seal holder 41 has sealing members 42 and 43 on the inner side and the outer side, respectively. The oil seal holder 41 and the sealing members 42 and 43 are inserted into the plunger 40. The sealing members 42 and 43 of the oil seal holder 41 suppress leakage of the fuel to the internal combustion engine, and suppress oil permeation from the internal combustion engine.

A spring seat 44 is fixed to an end portion on the lower side of the plunger 40. A first spring 45 is disposed between the spring seat 44 and the oil seal holder 41. The first spring 45 biases the plunger 40 against a cam shaft (not illustrated) of the internal combustion engine. Therefore, the plunger 40 reciprocates in the axial direction along a profile of the cam shaft to change a volume of the pressurizing chamber 25.

FIG. 2 illustrates a state where the plunger 40 is located at a top dead center. A position of the top dead center of the plunger 40 can be adjusted by setting the cam profile of the cam shaft.

The pressurizing chamber 25 for pressurizing the fuel is formed between the lower end surface 311 of the plug 30 and the upper end surface 46 of the plunger 40. The lower end surface 311 of the plug 30 is installed close to the top dead center of the plunger 40, and the volume of the pressurizing chamber 25 is caused to decrease. In this manner, when the plunger 40 ascends, the high-pressure pump 1 can cause the fuel of the pressurizing chamber 25 to have high pressure in a short time.

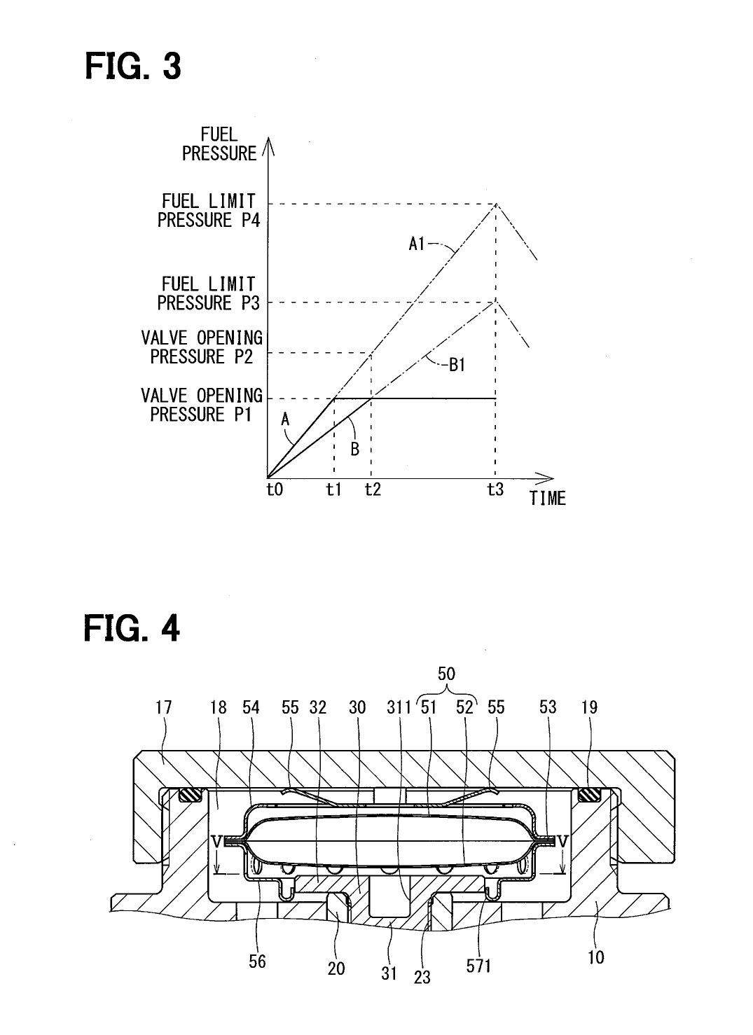

Here, characteristics in fuel discharge of the high-pressure pump 1 according to the first embodiment and a high-pressure pump 2 according to a comparative example will be described with reference to FIG. 3.

In FIG. 3, the plunger 40 is located in a bottom dead center at time t0, and is located in the top dead center at time t3.

A solid line A indicates the characteristics in the fuel discharge of the high-pressure pump 1 according to the first embodiment, a solid line B indicates the characteristics in the fuel discharge of the high-pressure pump 2 according to the comparative example. A two-dot chain line A1 indicates a state where the high-pressure pump 1 according to the first embodiment increases the fuel pressure, and a chain line B1 indicates a state where the high-pressure pump 2 according to the comparative example increases the fuel pressure. The state where the fuel pressure increases is meant by assuming an increase in the fuel pressure when the plunger 40 moves to the top dead center in a state where a discharge valve 82 is closed.

As illustrated in FIG. 14, the high-pressure pump 2 according to the comparative example has a configuration in which a center hole of a cylinder 200 is not open to the fuel chamber 18. In this case, a shape of an upper portion of a pressurizing chamber 250 is a conical shape taken along a shape of a distal end of a drill (not illustrated) which is used in forming the center hole of the cylinder 200. Therefore, the volume of the pressurizing chamber 250 according to the comparative example is larger than the volume of the pressurizing chamber 25 according to the first embodiment by a volume amount of a conical portion 251 thereof.

Here, a relationship between the fuel pressure and the volume of pressurizing chamber is expressed by Equation 1.

P=K×ΔV/V (Equation 1)

P: fuel pressure

K: bulk modulus of fuel

ΔV: volume of pressurizing chamber which varies when plunger moves from bottom dead center to top dead center

V: volume of pressurizing chamber when plunger is located at bottom dead center

When flow rates of the fuel discharged by the high-pressure pump 1 according to the first embodiment and the high-pressure pump 2 according to the comparative example are the same as each other, the same ΔV is obtained in the high-pressure pump 1 according to the first embodiment and the high-pressure pump 2 according to the comparative example.

In a case of V, the volume of the pressurizing chamber 25 according to the first embodiment is smaller than the volume of the pressurizing chamber 250 according to the comparative example by the volume amount of the conical portion 251 formed in the pressurizing chamber 250 of the high-pressure pump 2 according to the comparative example. Accordingly, fuel limit pressure P4 according to the high-pressure pump 1 of the first embodiment is higher than fuel limit pressure P3 according to the high-pressure pump 2 of the comparative example. Therefore, as compared to the high-pressure pump 2 according to the comparative example, the high-pressure pump 1 according to the present embodiment can cause the fuel of the pressurizing chamber 25 to have high pressure in a short time, when the plunger 40 ascends. Therefore, when valve opening pressure of the discharge valve 82 is set to P1, the high-pressure pump 1 according to the present embodiment discharges the fuel after time t1. In contrast, the high-pressure pump 2 according to the comparative example discharges the fuel after time t2 which occurs later than time t1. As a result, as compared to the high-pressure pump 2 according to the comparative example, the high-pressure pump 1 according to the present embodiment discharges the fuel for a longer period of time. Therefore, a discharge amount of high-pressure fuel can be increased.

When the high-pressure pump 1 according to the present embodiment is set to discharge the fuel after time t2, for example, similar to the comparative example, valve opening pressure P2 according to the present embodiment can be increased more than the valve opening pressure P1 according to the comparative example.

Here, when the valve opening pressure of the discharge valve 82 is increased more, it is considered that a load applied to a tappet roller (not illustrated) which transmits power between the plunger 40 and the cam shaft increases. In order to solve this problem, it is preferable to lengthen a stroke of a vertical movement of the plunger 40 by narrowing an outer diameter of the plunger 40 more than that in the comparative example. The stroke of the vertical movement of the plunger 40 can be changed by the cam profile of the cam shaft. This change can prevent damage to the tappet roller.

As illustrated in FIG. 2, the pulsation damper 50 is disposed in the fuel chamber 18. The pulsation damper 50 has two diaphragms 51 and 52 and outer edges 53 of the diaphragms 51 and 52 are joined to each other. Gas having predetermined pressure is kept in an inner side sealed space. In the pulsation damper 50, in response to a change in the fuel pressure inside the fuel chamber, the two diaphragms 51 and 52 are elastically deformed about center portions thereof in a plate thickness direction, thereby reducing fuel pressure pulsations of the fuel chamber 18.

In the pulsation damper 50, the outer edge 53 thereof is supported by an upper support member 54 and a lower support member 56. The upper support member 54 and the lower support member 56 of the present embodiment correspond to an example of a “supporter” according to an aspect of the present disclosure.

In the lower support member 56, an upper side end surface supports the outer edge 53 of the pulsation damper 50. In the lower support member 56, a locking portion 57 disposed on a lower side is fitted into a concave portion 100 disposed on an inner wall of the pump body 10 which forms the fuel chamber 18. The locking portion 57 and the concave portion 100 are fitted to each other, thereby regulating a radial movement of the lower support member 56.

In the upper support member 54, a lower side end surface supports the outer edge 53 of the pulsation damper 50. In the upper support member 54, a spring portion 55 extending upward comes into contact with an inner wall of the cover 17. The spring portion 55 of the upper support member 54 presses the locking portion 57 of the lower support member 56 against a bottom of the concave portion 100. The spring portion 55 of the present embodiment corresponds to a “pressing portion” according to an aspect of the present disclosure.

In this manner, the upper support member 54, the lower support member 56, and the pulsation damper 50 are fixed to the fuel chamber 18.

As illustrated in FIGS. 1 and 2, the fuel supply unit 60 has a suction valve body 61, a valve seat member 62, a suction valve 63, and the like.

The suction valve body 61 is formed in a cylindrical shape, and is fixed to the fuel supply unit attachment hole 15 of the pump body 10.

The valve seat member 62 is disposed on the pressurizing chamber side of the suction valve body 61. The valve seat member 62 has a suction passage 64 in which the fuel supplied from the fuel chamber 18 to the fuel supply unit attachment hole 15 through a fuel passage 181 flows into the pressurizing chamber 25, and has a valve seat 65 in an opening on the pressurizing chamber side of the suction passage 64. The valve seat member 62 has a hole which houses a shaft portion 632 of the suction valve 63 so as to be reciprocally movable.

As illustrated in FIG. 2, a ring-shaped first sealing member 66 is disposed between an inner wall on the pressurizing chamber side of the fuel supply unit attachment hole 15 and the valve seat member 62. The first sealing member 66 prevents the high-pressure fuel from leaking out to the fuel chamber 18 from the pressurizing chamber 25 through the fuel supply unit attachment hole 15.

The suction valve 63 has an umbrella portion 631, the shaft portion 632, and a flange portion 633, and the shaft portion 632 is housed in a hole of the valve seat member 62 so as to be reciprocally movable. In the suction valve 63, the umbrella portion 631 can be seated on or separated from the valve seat 65 of the valve seat member 62. As illustrated in FIG. 1, the flange portion 633 is disposed on an opposite side of the shaft portion 632 relative to the umbrella portion 631. A second spring 67 is disposed between the flange portion 633 and the valve seat member 62. The second spring 67 biases the suction valve 63 toward the valve seat 65.

The electromagnetic drive unit 70 has a flange 71, a fixed core 72, a movable core 73, a rod 74, a coil 75, a third spring 76, and the like.

The flange 71 is fixed to an outer wall of the suction valve body 61. The movable core 73 is disposed on an inner side of the suction valve body 61 so as to be reciprocally movable. The rod 74 is fixed to a center of the movable core 73. A guide member 77 fixed to the inner side of the suction valve body 61 supports the rod 74 so as to be reciprocally movable in the axial direction. The third spring 76 biases the movable core 73 and the rod 74 toward the pressurizing chamber 25. The rod 74 can press the suction valve 63 toward the pressurizing chamber 25.

The fixed core 72 is disposed on an opposite side of the movable core 73 relative to the pressurizing chamber 25, and the coil 75 is disposed on a radially outer side of the fixed core 72. When the coil 75 is energized through a terminal 781 of a connector 78, a magnetic flux flows in a magnetic circuit configured to have the movable core 73, the fixed core 72, the flange 71, a yoke 79, and the like. The movable core 73 and the rod 74 are magnetically drawn toward the fixed core 72 against a biasing force of the third spring 76.

In contrast, when the coil 75 is not energized, the magnetic flux flowing in the above-described magnetic circuit disappears. Consequently, the movable core 73 and the rod 74 are biased toward the pressurizing chamber 25 by the biasing force of the third spring 76.

The fuel discharge unit 80 has a discharge valve body 81, a discharge valve 82, a valve seat 83, a fourth spring 84, and the like.

The discharge valve body 81 has a discharge passage 85 in a center thereof, and is fixed to the fuel discharge unit attachment hole 16. A spring receiving member 86 is disposed on an inner side of the discharge valve body 81.

The discharge valve 82 is a ball valve, and can be seated on or separated from the valve seat 83 formed in a tapered shape on an inner wall of the fuel discharge hole 22 of the cylinder 20. The fourth spring 84 is formed in a tapered shape whose diameter on the discharge valve side is small and whose diameter on the spring receiving member side is large, and biases the discharge valve 82 against the valve seat 83.

As illustrated in FIG. 2, a ring-shaped second sealing member 87 is disposed between an inner wall on the pressurizing chamber side of the fuel discharge unit attachment hole 16 and the discharge valve body 81. The second sealing member 87 prevents the high-pressure fuel from leaking out to the fuel chamber 18 from the pressurizing chamber 25 through the fuel discharge unit attachment hole 16.

Next, an operation of the high-pressure pump 1 will be described.

### (1) Suction Stroke

When rotation of the cam shaft causes the plunger 40 to descend from the top dead center toward the bottom dead center, the volume of the pressurizing chamber 25 increases, and the fuel pressure decreases. The discharge valve 82 is seated on the valve seat 83, thereby closing the discharge passage 85.

In contrast, a pressure difference between the pressurizing chamber 25 and the suction passage 64 causes the suction valve 63 to move toward the pressurizing chamber 25 against the biasing force of the second spring 67. In this manner, the suction valve 63 is brought into a valve opened state.

The opening of the suction valve 63 causes the fuel of the fuel chamber 18 to flow into the pressurizing chamber 25 through the suction passage 64.

### (2) Metering Stroke

The rotation of the cam shaft causes the plunger 40 to ascend from the bottom dead center toward the top dead center, the volume of the pressurizing chamber 25 decreases. At this time, the coil 75 is not energized until a predetermined time period elapses. Accordingly, the rod 74 presses the suction valve 63 toward the pressurizing chamber 25 by using a biasing force of the third spring 76. Thus, the suction valve 63 maintains a valve opened state.

The opening of the suction valve 63 maintains a state where the pressurizing chamber 25 and the fuel chamber 18 communicate with each other. Therefore, the low-pressure fuel suctioned to the pressurizing chamber 25 once is caused to return to the fuel chamber 18, and the fuel pressure of the fuel chamber 18 is increased. In contrast, the pressure in the pressurizing chamber 25 does not increase.

When the coil 75 is energized at a predetermined time while the plunger 40 ascends from the bottom dead center toward the top dead center, the magnetic field generated in the coil 75 generates magnetic attraction between the fixed core 72 and the movable core 73. When the magnetic attraction becomes stronger than a difference between an elastic force of the second spring 67 and an elastic force of the third spring 76, the movable core 73 moves toward the fixed core 72. This movement releases a pressing force of the rod 74 which acts against the suction valve 63.

In this case, the elastic force of the second spring 67 and dynamic pressure of the low-temperature fuel discharged from the pressurizing chamber 25 to the suction passage side cause the suction valve 63 to move in a valve closing direction and to be seated on the valve seat 65, in response to the operation of the rod 74. With the above described operation, the pressurizing chamber 25 and the suction passage 64 are blocked from each other.

### (3) Discharge Stroke

After the suction valve 63 is closed, the fuel pressure in the pressurizing chamber 25 increases in response to the ascending of the plunger 40. When a force applied to the discharge valve 82 by the fuel pressure in the pressurizing chamber 25 is stronger than a total sum of a force applied to the discharge valve 82 by the fuel pressure on a fuel outlet side and the biasing force of the fourth spring 84, the discharge valve 82 is opened. Accordingly, the high-pressure fuel pressurized in the pressurizing chamber 25 is discharged from a fuel outlet 88.

In the course of the discharge stroke, the coil 75 is not energized. A force applied to the suction valve 63 by the fuel pressure in the pressurizing chamber 25 is stronger than the biasing force of the third spring 76. Accordingly, the suction valve 63 maintains the valve closed state.

The high-pressure pump 1 repeatedly performs the suction stroke, the metering stroke, and the discharge stroke. The high-pressure pump 1 pressurizes and discharges the fuel in an amount required for the internal combustion engine.

The high-pressure pump 1 according to the first embodiment has the following advantageous operation effects.

(1) In the first embodiment, the plug 30 is screwed into the inner threaded portion 23 of the cylinder 20 from the fuel chamber 18 and the plug 30 has the lower end surface 311 defining the inner wall of the pressurizing chamber 25 is formed in parallel to the end surface 46 of the plunger 40.

This configuration can decrease the volume of the pressurizing chamber 25 by installing the lower end surface 311 of the plug 30 so as to be close to the top dead center of the plunger 40. Therefore, when the plunger 40 ascends, the high-pressure pump 1 can cause the fuel of the pressurizing chamber 25 to have high pressure in a short time. Accordingly, the high-pressure pump 1 can increase a discharge amount of the high-pressure fuel.

The plug 30 is screwed into the cylinder 20 from the fuel chamber 18. Therefore, when the fuel of the pressurizing chamber 25 leaks out through a clearance between the inner threaded portion 23 of the cylinder 20 and the plug 30, the fuel flows into the fuel chamber 18. Accordingly, even when the pressure of the fuel pressurized in the pressurizing chamber 25 is increased by adjusting the discharge valve 82, the high-pressure pump 1 can prevent the fuel from leaking outward from the pump body 10.

(2) In the first embodiment, in the plug 30, the outer threaded portion 31 is screwed into the inner threaded portion 23 of the cylinder 20. In this manner, the head portion 32 comes into sealed contact with the end surface of the cylinder 20 in the axial direction.

In this manner, an axial force generated when the outer threaded portion 31 is screwed into the cylinder 20 can increase surface pressure between the end surface of the cylinder 20 and the head portion 32. Therefore, the high-pressure pump 1 increases the pressure of the fuel pressurized in the pressurizing chamber 25 by improving sealing performance in the pressurizing chamber 25.

When the outer threaded portion 31 is screwed into the cylinder 20, the head portion 32 of the plug 30 presses the cylinder 20 in a direction away from the fuel chamber 18. Therefore, compression stress is applied to the cylinder 20, and tensile stress is not applied thereto. Accordingly, delayed fracture of the cylinder 20 can be prevented.

(3) In the first embodiment, the cylinder 20 protrudes toward the fuel chamber 18 from the cavity 14 of the pump body 10.

In this manner, the cylinder 20 is press-fitted to the overall inner wall of the cavity 14. Accordingly, as compared to a case where the cylinder 20 is shortened than the cavity 14, a sealing surface between the cavity 14 and the cylinder 20 in the axial direction can be lengthened. Therefore, the high-pressure pump 1 can improve the sealing performance of the pressurizing chamber 25.

(4) In the first embodiment, in the pulsation damper 50, the locking portion 57 of the lower support member 56 is fitted to the concave portion 100 of the pump body 10, and the spring portion 55 of the upper support member 54 presses the locking portion 57 against the bottom of the concave portion 100. In this manner, the pulsation damper 50 is fixed to the fuel chamber 18.

In this manner, in the pulsation damper 50, the locking portion 57 of the lower support member 56 regulates a movement of the pulsation damper 50 in the radial direction, and the spring portion 55 of the upper support member 54 regulates a movement of the pulsation damper 50 in the axial direction. Therefore, the upper support member 54 and the lower support member 56 can fix the pulsation damper 50 to the fuel chamber 18 by using a simple configuration.

### Second Embodiment

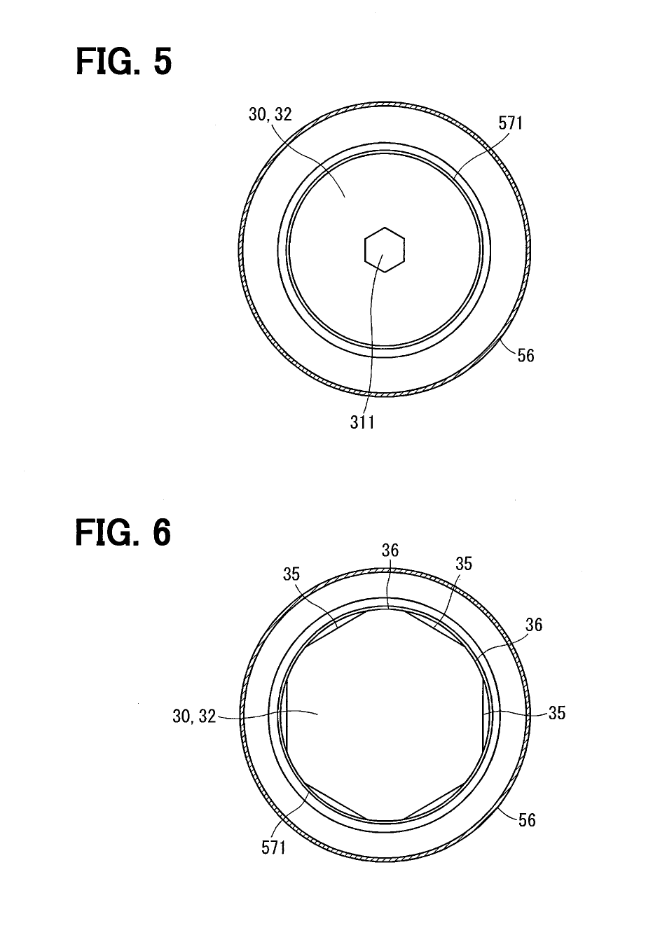

FIGS. 4 and 5 illustrate a cross-sectional view of a part of a high-pressure pump according to a second embodiment of the present disclosure. In the following multiple embodiments, the same reference numerals are given to configurations which are substantially the same as those in the above-described first embodiment, and descriptions thereof will be omitted.

In the second embodiment, a first locking portion 571 of a lower support member 56 supporting a pulsation damper 50 has a U-shaped cross section, and is formed so as to be wound radially inward from a radially outer side. An end surface of the first locking portion 571 in a radially inward direction is fitted to an outer wall of a head portion 32 of a plug 30 in a radially outward direction. In this manner, a movement of the lower support member 56 in the radial direction is regulated.

In contrast, a spring portion 55 of an upper support member 54 comes into contact with an inner wall of a cover 17, and presses the first locking portion 571 of the lower support member 56 against a pump body 10.

In this manner, in the pulsation damper 50, the first locking portion 571 of the lower support member 56 regulates a movement in the radial direction, and the spring portion 55 of the upper support member 54 regulates a movement in the axial direction.

Even in the second embodiment, the upper support member 54 and the lower support member 56 can fix the pulsation damper 50 to a fuel chamber 18 by using a simple configuration.

### Modification to Second Embodiment

FIG. 6 illustrates a plan view of a plug 30 according to a modification to the second embodiment of the present disclosure.

In the modification, multiple flat surfaces 35 are formed on an outer wall of a head portion 32 of a plug 30. The multiple flat surfaces 35 are connected to each other by an arcuate surface 36.

In the plug 30 of the modification example, a tool (not illustrated) is attached to the flat surface 35 on the outer wall of the head portion 32, and the tool is rotated. In this manner, an outer threaded portion 31 of the plug 30 can be screwed into an inner threaded portion 23 of a cylinder 20.

In a first locking portion 571 of a lower support member 56 supporting a pulsation damper 50, an inner wall in a radially inward direction thereof is locked by the arcuate surface 36 of the head portion 32 of the plug 30. In this manner, in the pulsation damper 50, a movement in the radial direction is regulated by the first locking portion 571 of the lower support member 56.

In the modification, it is also possible to obtain an advantageous operation effect which is the same as that in the above-described first and second embodiments.

### Third Embodiment

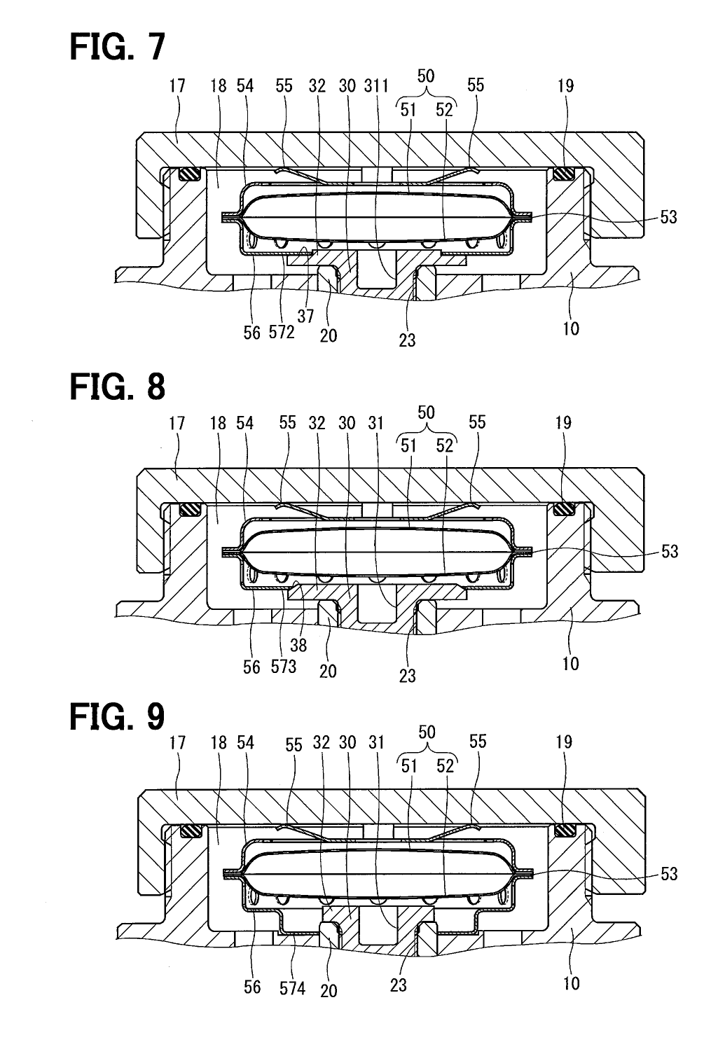

FIG. 7 illustrates a cross-sectional view of a part of a high-pressure pump according to a third embodiment of the present disclosure.

In the third embodiment, a plug 30 has an annular groove 37 (groove) which is recessed toward a pressurizing chamber 25, on an outer edge on an end surface on a counter pressurizing chamber side of a head portion 32. In other words, the annular groove 37 is recessed from the end surface of the head portion 32 that faces a pulsation damper 50.

A lower support member 56 has a second locking portion 572 which is fitted to the groove 37 of the plug 30. In the second locking portion 572, an end surface in the radially inward direction thereof can come into contact with an outer wall in the radially outward direction of the groove 37 of the plug 30. In this manner, a movement of the lower support member 56 in the radial direction is regulated.

In contrast, a spring portion 55 of an upper support member 54 comes into contact with an inner wall of a cover 17, and presses the second locking portion 572 of the lower support member 56 against a bottom of the groove 37 of the plug 30.

In this manner, in a pulsation damper 50, the second locking portion 572 of the lower support member 56 regulates a movement in the radial direction, and the spring portion 55 of the upper support member 54 regulates a movement in the axial direction.

In the third embodiment, it is also possible to obtain an advantageous operation effect which is the same as that in the above-described first and second embodiments.

### Fourth Embodiment

FIG. 8 illustrates a cross-sectional view of a part of a high-pressure pump according to a fourth embodiment of the present disclosure.

In the fourth embodiment, a plug 30 has a tapered portion 38 on an outer edge on an end surface on an opposite side of a head portion 32 relative to a pressurizing chamber 25. In the tapered portion 38, an outer diameter close to the pressurizing chamber 25 is larger than an outer diameter on an opposite side of the tapered portion 38 relative to the pressurizing chamber 25. In other words, the tapered portion 38 is formed on the head portion 32 and tapers radially outward toward the pressurizing chamber 25.

A lower support member 56 has a third locking portion 573 which comes into contact with the tapered portion 38 of the plug 30. In the third locking portion 573, an end surface in the radially inward direction thereof is located on a radially inner side from an outer periphery of the tapered portion 38 of the plug 30.

In contrast, a spring portion 55 of an upper support member 54 comes into contact with an inner wall of a cover 17, and presses the third locking portion 573 of the lower support member 56 against the tapered portion 38 of the plug 30.

In this manner, in a pulsation damper 50, the third locking portion 573 of the lower support member 56 regulates a movement in the radial direction, and the spring portion 55 of the upper support member 54 regulates a movement in the axial direction.

In the fourth embodiment, it is also possible to obtain an advantageous operation effect which is the same as that in the above-described first to third embodiments.

### Fifth Embodiment

FIG. 9 illustrates a cross-sectional view of a part of a high-pressure pump according to a fifth embodiment of the present disclosure.

In the fifth embodiment, a lower support member 56 has a fourth locking portion 574 which is fitted to an outer wall in the radially outward direction of a cylinder 20 protruding toward a fuel chamber 18. In other words, the fourth locking portion 574 is fitted to the outer wall of an end portion (one end) of the cylinder 20 immediately adjacent to the fuel chamber 18. In the fourth locking portion 574, an end surface in the radially inward direction thereof can come into contact with the outer wall in the radially outward direction of the cylinder 20. In this manner, a movement of the lower support member 56 in the radial direction is regulated.

In contrast, a spring portion 55 of an upper support member 54 comes into contact with an inner wall of a cover 17, and presses the fourth locking portion 574 of the lower support member 56 against a pump body 10.

In this manner, in a pulsation damper 50, the fourth locking portion 574 of the lower support member 56 regulates a movement in the radial direction, and the spring portion 55 of the upper support member 54 regulates a movement in the axial direction.

In the fifth embodiment, it is also possible to obtain an advantageous operation effect which is the same as that in the above-described first to fourth embodiments.

### Sixth Embodiment

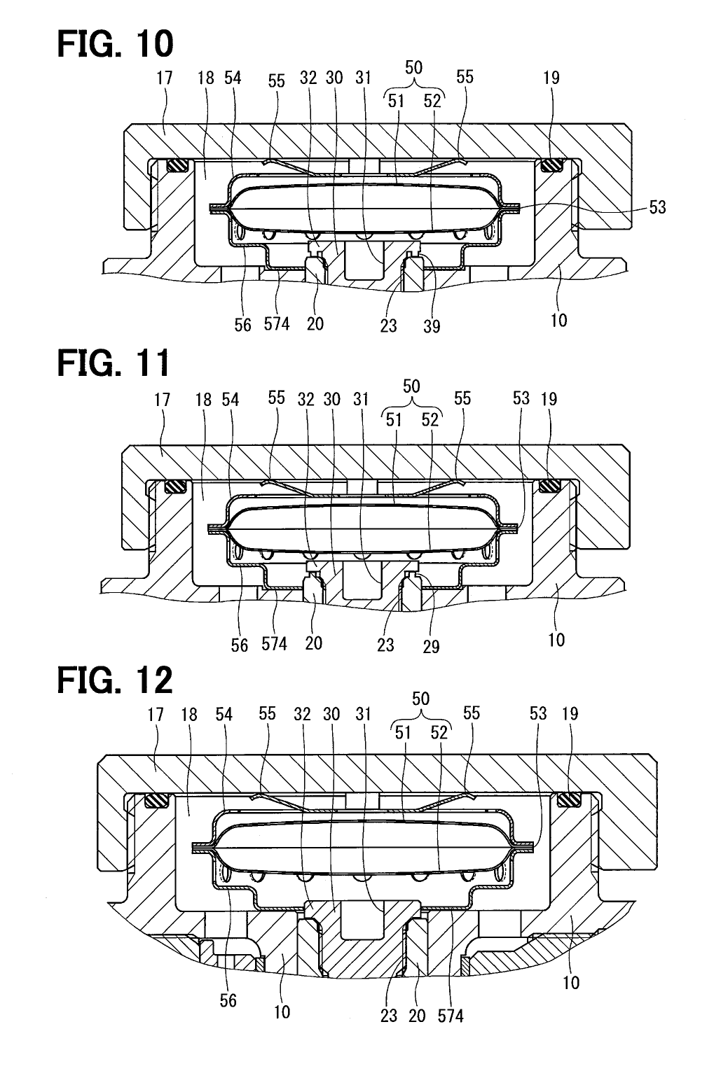

FIG. 10 illustrates a cross-sectional view of a part of a high-pressure pump according to a sixth embodiment of the present disclosure.

In the sixth embodiment, a head portion 32 of a plug 30 has a plug sealing portion 39 which extends in a cylindrical shape in the axial direction from an end surface on an opposite side of the head portion 32 relative to a fuel chamber 18. In other words, the plug sealing portion 39 extends from the head portion 32 in the axial direction away from the fuel chamber 18. Herein, the “cylindrical shape” indicates any shape as long as the shape continuously extends in a circumferential direction. For example, the shape also includes a tapered shape in which a thickness on the counter fuel chamber side of the plug sealing portion 39 is formed to be thinner than a thickness on a fuel chamber side of the plug sealing portion 39, i.e., tapering radially inward toward the fuel chamber 18.

The plug sealing portion 39 comes into sealed contact with an end surface on the fuel chamber side of a cylinder 20, thereby preventing fuel of a pressurizing chamber 25 from leaking out to a fuel chamber 18 through a clearance between an inner threaded portion 23 of the cylinder 20 and the plug 30. That is, the sealing portion 39 has sealed contact with the cylinder 20.

In the sixth embodiment, surface pressure between the plug sealing portion 39 and the cylinder 20 can be increased by adjusting the thickness of the plug sealing portion 39 in the radial direction. Therefore, the high-pressure pump can improve sealing performance of the pressurizing chamber 25.

### Seventh Embodiment

FIG. 11 illustrates a cross-sectional view of a part of a high-pressure pump according to a seventh embodiment of the present disclosure.

In the seventh embodiment, a cylinder 20 has a cylinder sealing portion 29 which extends in a cylindrical shape in the axial direction from an end surface on a fuel chamber side. In other words, the cylinder sealing portion 29 extends toward the fuel chamber 18 in the axial direction from an end portion (one end) of the cylinder 20 immediately adjacent to the fuel chamber 18. Herein, the “cylindrical shape” indicates any shape as long as the shape continuously extends in a circumferential direction. For example, the shape also includes a tapered shape in which a thickness on the counter fuel chamber side of the cylinder sealing portion 29 is formed to be thinner than a thickness on a fuel chamber side of the cylinder sealing portion 29, i.e., tapering radially inward toward the fuel chamber 18.

The cylinder sealing portion 29 comes into sealed contact with a head portion 32 of a plug 30, thereby preventing fuel of a pressurizing chamber 25 from leaking out to a fuel chamber 18 through a clearance between an inner threaded portion 23 of the cylinder 20 and the plug 30. In other words, the cylinder sealing portion 29 has sealed contact with the head portion 32 of the plug 30.

In the seventh embodiment, surface pressure between the cylinder sealing portion 29 and the head portion 32 of the plug 30 can be increased by adjusting the thickness of the cylinder sealing portion 29 in the radial direction. Therefore, the high-pressure pump can improve sealing performance of the pressurizing chamber 25.

### Eighth Embodiment

FIG. 12 illustrates a cross-sectional view of a part of a high-pressure pump according to an eighth embodiment of the present disclosure.

In the eighth embodiment, in a cylinder 20, an end surface immediately adjacent to a fuel chamber 18 is located closer to a pressurizing chamber 25 than an inner wall of a pump body 10 which forms the fuel chamber 18. In other words, the end surface of the cylinder 20 is shifted in an axial direction toward the pressurizing chamber 25 relative to the inner wall of the pump body 10. Therefore, in a plug 30, an outer diameter of a head portion 32 is formed to be smaller than an outer diameter of the cylinder 20. In this manner, the head portion 32 of the plug 30 can come into sealed contact with an end surface of the cylinder 20 in the axial direction, and can close an opening on the fuel chamber side of the cylinder 20.

### Ninth Embodiment

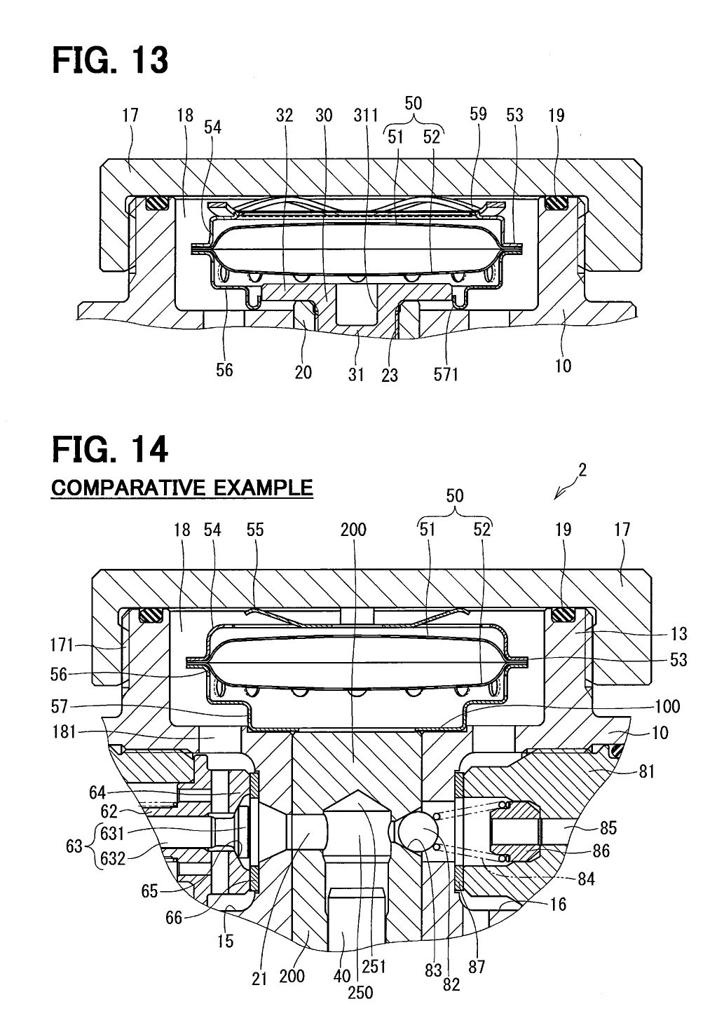

FIG. 13 illustrates a cross-sectional view of a part of a high-pressure pump according to a ninth embodiment of the present disclosure.

In the ninth embodiment, an upper support member 54 is pressed toward a pressurizing chamber 25 by a wave washer 59. The wave washer 59 of the present embodiment corresponds to a “pressing portion” according to an aspect of the present disclosure.

In contrast, a first locking portion 571 of a lower support member 56 is the same as that in the above-described second embodiment.

In this manner, in a pulsation damper 50, the first locking portion 571 of the lower support member 56 regulates a movement in the radial direction, and the wave washer 59 which presses an upper support member 54 regulates a movement in the axial direction. That is, a “supporter” according to an aspect of the present disclosure may be configured to have multiple members.

In the ninth embodiment, it is also possible to obtain an advantageous operation effect which is the same as that in the above-described first to eighth embodiments.

### Another Embodiment

In the above-described embodiments, a pump body and a cylinder are separately configured, and the cylinder is press-fitted to a cavity of the pump body. In contrast, in another embodiment, the pump body and the cylinder may be integrally formed.

In the above-described embodiments, an end surface of a plug defining a pressurizing chamber is formed to be flat, and is caused to be in parallel to an end surface of a plunger defining the pressurizing chamber. In contrast, in another embodiment, any other configuration may be adopted as long as the end surface of the plug defining the pressurizing chamber is in parallel to the end surface of the plunger defining the pressurizing chamber. For example, the end surface of the plug may be formed to have a convex and conical shape on the plunger side, and the end surface of the plunger may have an inverse conical shape which is in parallel to the convex and conical shape.

The present disclosure is not limited to the above-described multiple embodiments. In addition to combinations of the above-described multiple embodiments, the present disclosure can be embodied in various forms within a scope not departing from the spirit of the present disclosure.

What is claimed is:

1. A high-pressure pump comprising:
a pump body having a fuel chamber therein into which fuel is supplied;
a cylinder disposed inside the pump body and having one end immediately adjacent to the fuel chamber, the cylinder having an inner threaded portion formed on an inner wall of the cylinder at the one end;
a plunger disposed inside the cylinder and reciprocally movable in an axial direction to change a volume of a pressurizing chamber within which the fuel supplied from the fuel chamber is pressurized; and
a plug screwed into the inner threaded portion of the cylinder from the fuel chamber in the axial direction and closing the one end of the cylinder, wherein
the plug has an end surface that faces an end surface of the plunger and defines the pressurizing chamber together with the end surface of the plunger, and
the end surface of the plug is parallel to the end surface of the plunger.

2. The high-pressure pump according to claim 1, wherein
the plug includes
an outer threaded portion that is screwed into the inner threaded portion of the cylinder, and
a head portion extending outwardly in the radial direction from one end of the outer threaded portion immediately adjacent to the fuel chamber, the head portion having an annular shape and having sealed contact with the one end of the cylinder in the axial direction.

3. The high-pressure pump according to claim 2, wherein
the plug includes a plug sealing portion extending from the head portion in the axial direction away from the fuel chamber, the plug sealing portion having sealed contact with the cylinder.

4. The high-pressure pump according to claim 2, wherein
the cylinder includes a cylinder sealing portion extending from the one end of the cylinder toward the fuel chamber in the axial direction, the cylinder sealing portion having sealed contact with the head portion of the plug.

5. The high-pressure pump according to claim 1, wherein
the pump body has a cavity into which the cylinder is press-fitted, and
the one end of the cylinder protrudes from the cavity toward the fuel chamber.

6. The high-pressure pump according to claim 2, further comprising:
a pulsation damper disposed inside the fuel chamber; and
a supporter engaging the cylinder or the head portion of the plug located inside the fuel chamber to fix the pulsation damper inside the fuel chamber.

7. The high-pressure pump according to claim 6, wherein
the supporter includes
a first locking portion fitted to an outer wall of the head portion of the plug, and
a pressing portion disposed on an opposite side of the pulsation damper relative to the first locking portion, the pressing portion pressing the first locking portion against an inner wall of the fuel chamber.

8. The high-pressure pump according to claim 6, wherein
the plug has a groove recessed toward the pressurizing chamber from an end surface of the head portion that faces the pulsation damper, and
the supporter includes
a second locking portion fitted to the groove, and
a pressing portion disposed on an opposite side of the pulsation damper relative to the second locking portion, the pressing portion pressing the second locking portion against a bottom of the groove.

9. The high-pressure pump according to claim 6, wherein
the plug has a tapered portion formed on the head portion and tapering radially outward toward the pressurizing chamber, and
the supporter includes
a third locking portion contacting the tapered portion, and
a pressing portion disposed on an opposite side of the pulsation damper relative to the third locking portion, the pressing portion pressing the third locking portion against the tapered portion.

10. The high-pressure pump according to claim 6, wherein
the supporter includes
a fourth locking portion fitted to an outer wall of the one end of the cylinder that protrudes into the fuel chamber, and
a pressing portion disposed on an opposite side of the pulsation damper relative to the fourth locking portion, the pressing portion pressing the fourth locking portion against an inner wall of the fuel chamber.
